(19) United States
(12) Patent Application Publication
(10) Pub. No.: US 2025/0199177 A1
(43) Pub. Date: Jun. 19, 2025

(54) Method and Device for Validating a Distance Measurement

(71) Applicant: Bayerische Motoren Werke Aktiengesellschaft, Muenchen (DE)

(72) Inventors: Bartono ADIPRASITO, Tiefenbach (DE); Maximilian GUENTHER, Muenchen (DE); Frank HERCHET, Neufahrn b. Freising (DE); Martin JAENSCH, Muenchen (DE); Markus KRAEMER, Dachau (DE); Julius SCHULZ, Muenchen (DE); Muhammed YILDIZ, Kirchseeon (DE)

(21) Appl. No.: 18/848,962

(22) PCT Filed: Mar. 15, 2023
(86) PCT No.: PCT/EP2023/056670

§ 371 Date: Sep. 20, 2024

(30) Foreign Application Priority Data
Mar. 23, 2022 (DE) 10 2022 106 744.0

(51) Int. Cl. G01S 17/08; B60W 60/00

(52) U.S. Cl. CPC G01S 17/08; B60W 60/001; B60W 2420/403

(57) ABSTRACT

The present disclosure relates to a device for verifying distance measurement values related to the distance of a vehicle from an object during an approach of the vehicle to the object. The device is configured to determine a measurement value at two successive waypoints on a roadway to the object, each based on environmental data from one or more environmental sensors of the vehicle, and to determine an odometry-based path distance between the two successive waypoints, on the basis of movement data of one or more movement sensors of the vehicle. The device is further configured, on the basis of the odometry-based path distance, to determine a value of a quality measure in relation to the quality of the distance measurement values, and to operate the vehicle on the basis of the determined value of the quality measure.

### BACKGROUND AND SUMMARY

The invention relates to a method and a corresponding device for validating a sensor-based, in particular a camera-based, distance measurement in a vehicle.

A vehicle has one or more surroundings sensors (in particular one or more cameras), which are configured to acquire surroundings data with respect to the surroundings (upcoming in the direction of travel) of the vehicle. An upcoming signaling unit (e.g. a traffic sign or a traffic signal) can be detected on the basis of the surroundings data. Furthermore, the distance of the detected signaling unit from the vehicle can be measured on the basis of the surroundings data. The vehicle can then be operated depending on the measured distance of the detected signaling unit, for example to cause automatic braking at the stopping line of the detected signaling unit.

The distance measurement on the basis of surroundings data, in particular on the basis of the camera data of a mono camera, can be subject to measurement errors, which can result in impairments of a driving function operated on the basis of the distance measurement.

The present document relates to the technical problem of checking the quality of a distance measurement in an efficient and reliable manner, in particular in order to increase the quality of a driving function of a vehicle based thereon.

The object is achieved by each of the independent claims. Advantageous embodiments and implementations are described, inter alia, in the dependent claims. It is noted that additional features of a claim dependent on an independent claim, without the features of the independent claim or only in combination with a subset of the features of the independent claim, can form a separate invention independent of the combination of all features of the independent claim, which can be made the subject matter of an independent claim, a divisional application, or a continuing application. This applies in the same manner to technical teachings which are described in the description and can form an invention independent of the features of the independent claims.

According to one aspect, a device (or a control unit) for checking distance measured values with respect to the distance of a (motor) vehicle to an object during an approach operation of the vehicle to the object is described. The object can be a signaling unit, in particular a traffic light system (such as a traffic signal) or a traffic sign (e.g. a stop sign).

The device is configured to determine a distance measured value at two successive waypoints on a roadway to the object in each case on the basis of surroundings data from one or more surroundings sensors of the vehicle. The one or more surroundings sensors of the vehicle can comprise (possibly only and/or possibly exactly) one camera, in particular a mono camera. The surroundings data can comprise (possibly only) one or more camera images, which were acquired by the (possibly single) camera of the vehicle. In particular if distance measured values are determined solely on the basis of the camera images of a single mono camera, the distance measured values can have relatively high measurement errors.

The device is furthermore configured to determine an odometry-based route distance between the two successive waypoints on the basis of movement data from one or more movement sensors of the vehicle. The one or more movement sensors of the vehicle can comprise a wheel speed sensor and/or a velocity sensor of the vehicle. The movement data can indicate here the movement of the vehicle in the longitudinal and/or transverse direction (for example along the x axis and/or the y axis of the vehicle). The position of the vehicle on the x/y plane and/or the rotation of the vehicle around the z axis (i.e. around the vertical axis) can be taken into consideration here. The route distance of the vehicle 100, which the vehicle has covered within the x/y plane, can thus be determined in a precise manner. In particular, curves of the route distance can thus be taken into consideration in a precise manner.

Furthermore, the device is configured to determine a value of a quality measure with respect to the quality, in particular with respect to the accuracy, of the distance measured values on the basis of the odometry-based route distance. The device can be configured in particular to determine a change of the distance measured values at the two successive waypoints. For example, the difference between the two distance measured values can be determined. The value of the quality measure can then be determined with particularly high accuracy (also) depending on the change, in particular depending on the difference, of the distance measured values, for example depending on a comparison of the change of the distance measured values to the odometry-based route distance.

Odometry data can therefore be taken into consideration in order to check the quality, in particular the accuracy, of (camera-based) distance measured values. Efficient and reliable validation of distance measured values can thus be enabled.

The device can furthermore be configured to operate the vehicle, in particular a function of the vehicle, depending on the determined value of the quality measure. It can be decided here depending on the determined value of the quality measure whether or not the distance measured values are taken into consideration in the operation of the vehicle, in particular in the operation of the function of the vehicle.

The device can be configured, for example, to operate a driving function for the at least partially automated longitudinal and/or lateral control of the vehicle (e.g., an adaptive cruise control and/or cruise control and/or an emergency braking function) depending on the determined value of the quality measure. The device can be configured in particular, to cause, depending on the determined value of the quality measure, (if the quality measure indicates a sufficiently high quality of the distance measured values) automated braking of the vehicle at the object (for example at a red traffic signal) or to prevent it (if the quality measure indicates an inadequate quality of the distance measured values). Particularly reliable operation of a driving function can thus be enabled.

xn-1 can be the distance measured value at the waypoint n-1, and xn can be the distance measured value at the waypoint n, which (directly and/or immediately) follows the waypoint n-1 during the approach operation. Δn-1,n can be the odometry-based route distance between the waypoints n-1 and n.

The device can be configured to determine a measured value change xn-1,n=(xn-1-xn) and to compare the measured value change xn-1,n to the odometry-based route distance Δn-1,n. The value of the quality measure can then be determined, in particular (iteratively) adapted, in a particularly precise manner depending on the comparison.

The device can be configured, for example, to determine the difference dn-1,n between the measured value change xn-1,n and the odometry-based route distance Δn-1,n. The difference dn-1,n (in particular the absolute value of the difference) can then be compared to a difference threshold value, and the value of the quality measure can be determined, in particular increased or reduced, depending on the comparison to the difference threshold value. For example, the device can be configured to increase the value of the quality measure if the difference dn-1,n is smaller in absolute value than the difference threshold value, and/or to reduce the value of the quality measure if the difference dn-1,n is greater in absolute value than the difference threshold value. In such a case, a high value of the quality measure indicates a high quality, in particular a high accuracy, of the distance measured values, and a low value of the quality measure indicates a low quality of the distance measured values. It is to be noted that the meaning of the value of the quality measure can be precisely the inverse. The (iterative) adaptation of the value of the quality measure and/or the evaluation of the value of the quality measure then takes place in a correspondingly inverse manner.

The device can be configured to change the value of the quality measure more strongly (i.e. to change it by a higher adaptation value), in particular to increase it, the less the measured value change xn-1,n deviates in absolute value from the odometry-based route distance Δn-1,n. Alternatively or additionally, the device can be configured to change the value of the quality measure more strongly (i.e. to change it by a higher adaptation value), in particular to reduce it, the more the measured value change xn-1,n deviates in absolute value from the odometry-based route distance Δn-1,n. A particularly precise indicator for the accuracy of the distance measured values can thus be provided.

As already described above, the value of the quality measure can be iteratively adapted during an approach operation. The value of the quality measure can be initialized here at the beginning of the approach operation using an initial value and then be iteratively adapted during the approach operation. In particular, the device can be configured to determine, at a sequence of successive waypoints n (where n>1) during the approach operation, a distance measured value at the respective waypoint n (on the basis of the surroundings data for the respective waypoint n). Furthermore, a measured value change xn-1,n for the distance measured value can be determined at the respectively (directly) preceding waypoint n-1.

The device can furthermore be configured to determine an odometry-based route distance Δn-1,n between the respectively successive waypoints n, n-1 (on the basis of the respectively relevant movement data of the one or more movement sensors). The respective measured value change xn-1,n can then be compared to the respective odometry-based route distance Δn-1,n, and the value of the quality measure can be adapted iteratively (in each case by an adaptation value), in particular increased or reduced, depending on the respective comparison. The quality of the distance measured values can thus be evaluated during an approach operation in a particularly precise manner.

The device can be configured to take into consideration one or more further measured variables in the determination of the value of the quality measure. Exemplary measured variables are:
the driving velocity of the vehicle;
the period of time between two directly successive measurement points and/or waypoints n, n+1; and/or.
the (absolute) value of the distance of the vehicle from the object.

The accuracy of the determined value of the quality measure can be further increased by the consideration of one or more further measured variables.

The device can be configured in particular to determine, in the context of the iterative adaptation of the value of the quality measure, a weighting value, using which the respective adaptation value can be weighted (for example multiplied) to adapt the value of the quality measure. The weighting value can depend here on one or more of the abovementioned measured variables. For example, the weighting value can be reduced with increasing driving velocity, increased with increasing period of time between two directly successive measurement points and/or waypoints, and/or increased with decreasing (absolute) value of the distance of the vehicle from the object. The accuracy of the determined value of the quality measure can thus be increased in a particularly effective manner.

The device can be configured to iteratively adapt the value of the quality measure at the sequence of successive waypoints during the approach operation, and to limit in the process the value of the quality measure to a value range between a minimum value and a maximum value. Such a value limiting of the quality measure can cause the quality measure to react promptly to a change of the quality of the distance measured values during an approach operation, so that such a quality change can be detected promptly.

The device can therefore be configured to adapt, in particular increase or reduce, the value of the quality measure at the respective waypoint proceeding from the value of the quality measure at the (directly and/or immediately) preceding waypoint at a sequence of successive waypoints during the approach operation to the detected object. The value of the quality measure at the respective waypoint can be compared to at least one threshold value and it can be determined depending on the comparison whether or not the distance measured value at the respective waypoint has a sufficiently high quality for use in the operation of the function of the vehicle.

The device can be configured in particular to compare the value of the quality measure at the respective waypoint to an upper threshold value. It can then be determined that the distance measured value at the respective waypoint has a sufficiently high quality (and therefore can be taken into consideration during operation of the function of the vehicle) if the value of the quality measure is equal to or greater than the upper threshold value.

The device can furthermore be configured to determine that the distance measured value at one or more following waypoints has in each case a sufficiently high quality as long as the value of the quality measure is greater than a lower threshold value, wherein the lower threshold value is less than the upper threshold value. After reaching or falling below the lower threshold value, the quality of the distance measured values can then be classified as inadequate (as long as the value of the quality measure does not (again) reach or exceed the upper threshold value).

The quality of the distance measured values can be classified in a particularly precise and robust manner by a threshold value comparison of the determined value of the quality measure.

According to a further aspect, a (road) motor vehicle (in particular a passenger vehicle or a truck or a bus or a motorcycle) is described, which comprises the device described in this document.

According to a further aspect, a method for checking distance measured values with respect to the distance of a (motor) vehicle to an object during an approach operation of the vehicle to the object is described. The method comprises determining, at two successive waypoints on a roadway to the object, in each case a distance measured value on the basis of surroundings data from one or more surroundings sensors of the vehicle. The object can have been detected here on the basis of the surroundings data of the one or more surroundings sensors. Furthermore, the method comprises determining, on the basis of movement data from one or more movement sensors of the vehicle, an odometry-based route distance between the two successive waypoints, and determining, on the basis of the odometry-based route distance, a value of a quality measure with respect to the quality of the distance measured values. The distance measured values can then be checked on the basis of the value of the quality measure. Furthermore, the method can comprise operating the vehicle, in particular a function of the vehicle, depending on the determined value of the quality measure.

According to a further aspect, a software (SW) program is described. The SW program can be configured to be executed on a processor (for example on a control unit of a vehicle), and to thus carry out the method described in this document.

According to a further aspect, a storage medium is described. The storage medium can comprise an SW program, which is configured to be executed on a processor and to thus carry out the method described in this document.

It is to be noted that the methods, devices, and systems described in this document can be used both alone and in combination with other methods, devices, and systems described in this document. Furthermore, any aspects of the methods, devices, and systems described in this document can be combined with one another in a variety of ways. In particular, the features of the claims can be combined with one another in a variety of ways. Furthermore, features set forth in parentheses are to be understood as optional features.

### BRIEF DESCRIPTION OF THE DRAWINGS

The invention will be described in more detail hereinafter with reference to exemplary embodiments. In the figures

FIG. 1 shows exemplary components of a vehicle;

FIG. 2 shows an exemplary driving situation in which a vehicle drives toward a signaling unit;

FIG. 3a shows exemplary distance measured values during approach to an object;

FIG. 3b shows an exemplary quality measure and limiting values and/or threshold values associated therewith;

FIG. 3c shows an exemplary change of the value of the quality measure during an approach operation to an object; and

FIG. 4 shows a flow chart of an exemplary method for validating a distance measurement.

### DETAILED DESCRIPTION OF THE DRAWINGS

As described at the outset, the present document relates to the efficient and reliable checking of the quality of a sensor-based distance measurement, in particular in order to increase the quality of a driving function of a vehicle based thereon. In this context, FIG. 1 shows an exemplary vehicle 100, which comprises one or more surroundings sensors 102 (e.g. a camera, a lidar sensor, a radar sensor, an ultrasonic sensor), which are configured to acquire surroundings data with respect to the surroundings of the vehicle 100. A (control) device 101 of the vehicle 100 can be configured to identify an object (in particular a signaling unit) arranged in front of the vehicle 100 in the direction of travel on the basis of the surroundings data of the one or more surroundings sensors 102.

Furthermore, a distance measured value with respect to the distance of the object from the vehicle 100 (or with respect to the distance of the vehicle 100 from the object) can be determined on the basis of the surroundings data. For example, a signaling unit (e.g. a traffic signal or a traffic sign) can be identified on the basis of an image acquired by a camera. Furthermore, under the assumption of a typical, actual, size of the signaling unit, a distance measured value can be determined on the basis of the image, in particular on the basis of the size of the signaling unit in the image.

The vehicle 100 can furthermore comprise one or more longitudinal and/or lateral control actuators 103 (e.g. a drive motor, a braking device, and/or a steering device). The (control) device 101 can be configured to actuate the one or more actuators 103 depending on the detected object and/or depending on the determined distance measured value in order to provide a driving function, in particular a driver assistance function, of the vehicle 100. For example, an automated deceleration of the vehicle 100 can be caused on the basis of the distance measured value, so that the vehicle 100 comes to a standstill before reaching the object or at the object.

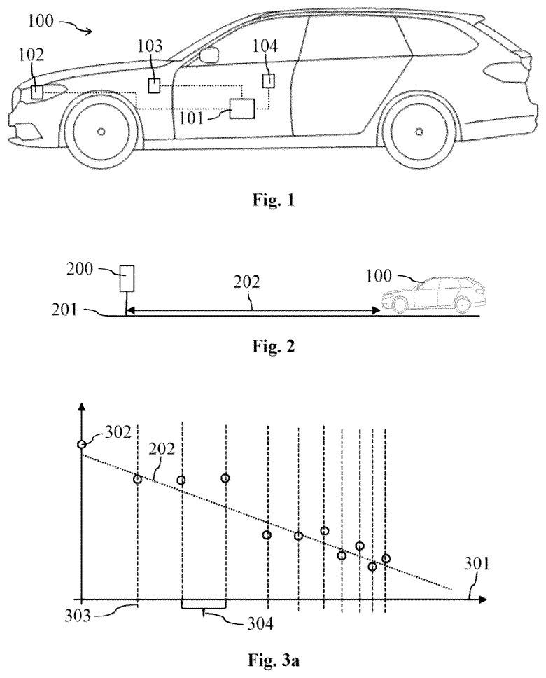

FIG. 2 shows an exemplary driving situation in which the vehicle 100 drives on a roadway 201 toward a signaling unit 200 (in general toward an object). The vehicle 100 has a distance and/or a determined spacing 202 from the signaling unit 200, which is gradually reduced during the approach operation of the vehicle 100.

The quality of distance measured values which are determined on the basis of the surroundings data of the one or more surroundings sensors 102 can be impaired in particular in the case of relatively small objects, such as in the case of signaling units. This can result in an impairment of a driving function of the vehicle 100, in which the distance measured values are used.

The vehicle 100 can comprise one or more movement sensors 104, which are configured to acquire movement data with respect to the movement of the vehicle 100. Exemplary movement sensors 104 are an inertial measuring unit, an acceleration sensor, a wheel speed sensor, a velocity sensor. The (control) device 101 can be configured to determine, on the basis of the movement data of the one or more movement sensors 104, the route distance which the vehicle 100 covers when approaching a signaling unit 200. The route distance determined on the basis of the movement data can be designated as an odometry-based route distance because methods of odometry (in particular using wheel speed measurements) can be used to determine the route distance. In particular, the route distance covered by the vehicle 100 between successive measurement points of distance measured values can be determined in this case.

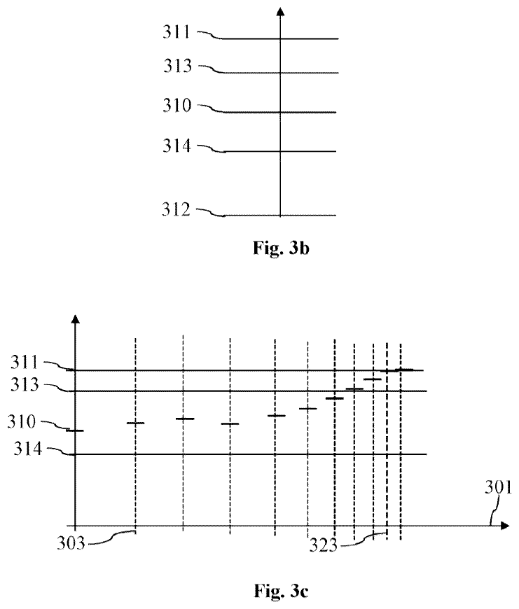

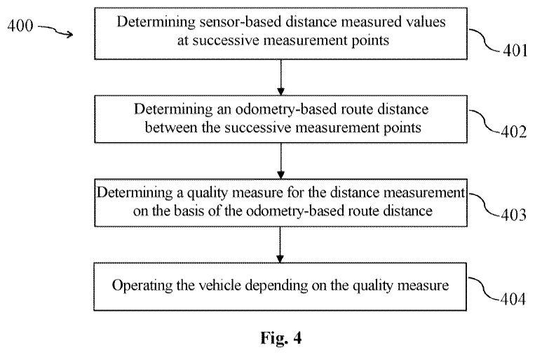

When approaching a signaling unit 200, distance measured values can be determined repeatedly by the device 101 at successive measurement points or waypoints on the basis of the surroundings data. This is shown by way of example in FIG. 3a. In particular, FIG. 3a shows the chronological development of the (actual) distance 202 of the vehicle 100 from the signaling unit 200 during an approach operation of the vehicle 100. The dotted straight line indicates here how the actual distance 202 decreases with increasing route distance 301, which the vehicle 100 covers (a different (larger) scale was selected here in FIG. 3a for the route distance 301 than for the distance 202).

During the approach operation, a distance measured value 302 can be determined repeatedly, at a sequence of successive waypoints and/or measurement points 303. The distance measured value 302 for a waypoint 303 typically deviates here (at least minimally, for instance due to measurement noise) from the actual distance 202.

The route distance covered between two waypoints 303 can be determined on the basis of the movement data of the one or more movement sensors 104. In particular, an odometry-based route distance 304 can be determined for the route distance between two waypoints 303. The route distance between two waypoints 303 can vary here, for example due to velocity changes of the vehicle 100 (if the measured values 302 are acquired at a fixed measurement frequency).

The odometry-based route distances 304 determined during an approach operation can be used to check the quality of the determined distance measured values 302. For this purpose, the value of a quality measure can be updated during the approach operation in an iterative manner, wherein the value of the quality measure indicates the quality of the distance measured value 302 (at the respective waypoint 303).

As shown by way of example in FIG. 3b, the quality measure 310 can assume values on a linear scale, in particular values between a minimum value 312 (for example 0) and a maximum value 311 (for example 10). Furthermore, one or more threshold values 313, 314 can be defined to which the value of the quality measure 310 can be compared in order to decide whether or not the distance measured values 302 have a sufficiently high quality (for use in a driving function). An upper threshold value 313 and a lower threshold value 314 can be defined, for example. The distance measured values 302 can be classified as sufficiently accurate if the value of the quality measure 310 is equal to or greater than the upper threshold value 313. On the other hand, the distance measured values 302 can be classified as inadequate if the value of the quality measure 310 is equal to or less than the lower threshold value 314.

If a signaling unit 200 is detected and a first distance measured value 302 is determined at a first waypoint 303, the quality measure 310 can be initialized using an initial value (for example in the middle between the minimum value 312 and the maximum value 311). When approaching the signaling unit 200, as shown by way of example in FIGS. 3a and 3c, current distance measured values 302 can then be determined sequentially at individual waypoints 303.

The distance measured value 302 for a waypoint n 303 can be designated as xn, and the odometry-based route distance 304 between the waypoints n-1 and n can be designated as Δn-1,n. At a waypoint n 303, the difference or change between the directly successive distance measured values 302 xn-1,n=(xn-1-xn) can then be compared to the odometry-based route distance 304 Δn-1,n between these two waypoints 303. In particular, the difference dn-1,n=xn-1,n-Δn-1,n between the measured value change and the odometry-based route distance 304 Δn-1,n can be determined. If the difference dn-1,n is less in absolute value than a defined difference threshold value, the value of the quality measure 310 can be increased (in order to indicate a higher quality of the distance measured value xn 302). On the other hand, if the difference dn-1,n is greater in absolute value than a defined difference threshold value, the value of the quality measure 310 can be reduced (in order to indicate a reduced quality of the distance measured value xn 302).

As already described further above, the scale of the values of the quality measure 310 can be inverted in an alternative example, so that a relatively low value of the quality measure 310 indicates a relatively high quality and/or a relatively high value of the quality measure 310 indicates a relatively low quality. In this case, the value of the quality measure 310 can be reduced (in order to indicate a higher quality of the distance measured value xn 302) if the difference dn-1,n is less in absolute value than a defined difference threshold value. On the other hand, if the difference dn-1,n is greater in absolute value than a defined difference threshold value, the value of the quality measure 310 can be increased (in order to indicate a reduced quality of the distance measured value xn 302).

The extent of the adaptation of the value of the quality measure 310 can possibly depend on the absolute value of the difference dn-1,n. The value of the quality measure 310 can be increased more strongly (or alternatively reduced) the less the absolute value of the difference dn-1,n is. On the other hand, the value of the quality measure 310 can possibly be reduced more strongly (or alternatively increased) the greater the absolute value of the difference dn-1,n is. As soon as the value of the quality measure 310 reaches the maximum value 311, a further increase of the value of the quality measure 310 can possibly be prevented. In a corresponding manner, a further reduction of the value of the quality measure 310 below the minimum value 312 can be prevented.

FIG. 3c illustrates how the value of the quality measure 310 is adapted (in each case at a waypoint or measurement point 303) iteratively during the approach operation from FIG. 3a. Furthermore, at each individual waypoint 303, the value of the quality measure 310 can be compared to the threshold values 313, 314. If the value of the quality measure 310 reaches or exceeds the upper threshold value 313 at a waypoint 303, it can be determined that the distance measured values 302 determined on the basis of the surroundings data have a sufficiently high quality (and can therefore be used in the scope of a driving function). This classification can be maintained in the further course of the approach operation until the value of the quality measure 310 reaches or falls below the lower threshold value 314. It can then be determined that the quality of the distance measured values 302 is inadequate. This classification can be maintained in the further course of the approach operation until the value of the quality measure 310 (possibly again) reaches or exceeds the upper threshold value 413.

As described at the outset, in particular if optical sensors (cameras) 102 are used which are not designed stereoscopically, uncertainties with respect to the determined distance can occur upon the positioning of objects in three-dimensional space. In particular objects 200 having a relatively small end face, e.g. traffic signals, can be subjected here to relatively strong measurement errors with respect to the positioning. The measures described in this document enable such a measurement error to be identified early.

The distance of an object 200 can be measured on the basis of the camera data of a one-lens camera 102 by a distance estimation on the basis of the size of the object 200. In the course of time (during an approach operation), a Kalman filter can be used here to provide distance measured values 302 iteratively.

As described in this document, a score 310, i.e. a quality measure, can be calculated on the basis of the comparison of the distance measurements 302 of an object 200 to odometry expectations 304 on the time curve (and possibly other attributes) of the distance measurements 302. This score 310 can be used to assess the trustworthiness of the distance or spacing measurements 302.

The device 101 can be configured to check during an approach operation to a traffic light system 200 whether or not the distance measured values 302 have a sufficiently high quality. If it is determined that the distance measured values 302 have a sufficiently high quality, automatic braking can possibly be caused at the traffic light system 200. On the other hand, if it is determined that the distance measured values 302 do not have a sufficiently high quality, automatic braking at the traffic light system 200 can possibly be suppressed, which can be communicated to the driver via the user interface of the vehicle 100. The reliability of a driving function for at least partially automated driving can thus be increased.

FIG. 4 shows a flow chart of an exemplary (possibly computer-implemented) method 400 for checking distance measured values 302 with respect to the distance 202 of a vehicle 100 from an object 200 (in particular from a signaling unit, for instance from a traffic light system or from a traffic sign) during an approach operation of the vehicle 100 to the object 200. The object 200 can have been detected on the basis of the surroundings data from one or more surroundings sensors 102 of the vehicle 100.

The method 400 comprises determining 401 at two successive waypoints 303 on a roadway 201 to the object 200 in each case a distance measured value 302 on the basis of the surroundings data (in particular possibly solely on the basis of camera data) from one or more surroundings sensors 102 (in particular from (precisely) one camera) of the vehicle 100.

The method 400 furthermore comprises determining 402, on the basis of movement data from one or more movement sensors 104 (in particular on the basis of the speed data of a wheel speed sensor) of the vehicle 100, an odometry-based route distance 304 between the two successive waypoints 303.

Furthermore, the method 400 comprises determining 403, on the basis of the odometry-based route distance 304, a value of a quality measure 310 with respect to the quality of the distance measured values 302. The vehicle 100, in particular a function of the vehicle 100, can then be operated depending on the determined value of the quality measure 310 (step 404). The quality of the function of the vehicle 100 can thus be increased.

The present invention is not restricted to the exemplary embodiments shown. In particular, it is to be noted that the description and the figures are only supposed to illustrate the principle of the proposed methods, devices, and systems by way of example.

1-15. (canceled)

16. A device for checking distance measured values with respect to a distance of a vehicle to an object during an approach operation of the vehicle to the object, wherein the device is configured to:
determine, at two successive waypoints on a roadway to the object, in each case a distance measured value on the basis of surroundings data from one or more surroundings sensors of the vehicle;
determine, on the basis of movement data from one or more movement sensors of the vehicle, an odometry-based route distance between the two successive waypoints;
determine, on the basis of the odometry-based route distance, a value of a quality measure with respect to a quality of the distance measured values; and
operate a function of the vehicle depending on the determined value of the quality measure.

17. The device according to claim 16, wherein the device is configured to:
determine a change of the distance measured values at the two successive waypoints; and
determine the value of the quality measure depending on the change of the distance measured values based on a comparison of the change of the distance measured values to the odometry-based route distance.

18. The device according to claim 16, wherein:
xn-1 is a distance measured value at the waypoint n-1;
xn is a distance measured value at the waypoint n, which follows the waypoint n-1 during the approach operation;
Δn-1,n is the odometry-based route distance between the waypoints n-1 and n; and
the device is configured to:
determine a measured value change xn 1,n=(xn-1-xn);
compare the measured value change xn-1,n to the odometry-based route distance Δn-1,n (304); and
determine the value of the quality measure depending on the comparison.

19. The device according to claim 18, wherein the device is configured to:
determine a difference dn-1,n between the measured value change xn-1,n and the odometry-based route distance Δn-1,n;
compare the difference dn-1,n to a difference threshold value; and
determine to increase or reduce the value of the quality measure depending on the comparison to the difference threshold value.

20. The device according to claim 19, wherein the device is configured to:
increase the value of the quality measure when the difference dn-1,n is less in absolute value than the difference threshold value; or
reduce the value of the quality measure when the difference dn-1,n is greater in absolute value than the difference threshold value.

21. The device according to claim 18, wherein the device is configured to at least one of:
increase the value of the quality measure more strongly, the less the measured value change xn-1,n deviates in absolute value from the odometry-based route distance Δn-1,n; or
reduce the value of the quality measure more strongly, the more the measured value change xn-1,n deviates in absolute value from the odometry-based route distance Δn-1,n.

22. The device according to claim 18, wherein the device is configured to, at a sequence of successive waypoints n during the approach operation:
determine a distance measured value at the respective waypoint n;
determine a measured value change xn-1,n from the distance measured value at the respectively preceding waypoint n-1;
determine an odometry-based route distance Δn-1,n between the respectively successive waypoints n, n-1;
compare the respective measured value change xn-1,n to the respective odometry-based route distance Δn-1,n; and
iteratively adapt to increase or to reduce the value of the quality measure depending on the respective comparison.

23. The device according to claim 22, wherein the device is configured to:
iteratively adapt, at the sequence of successive waypoints during the approach operation, the value of the quality measure to delimit the value of the quality measure to a value range between a minimum value and a maximum value.

24. The device according to claim 16, wherein the device is configured to, at a sequence of successive waypoints during the approach operation:
one of increase or to reduce the value of the quality measure at the respective waypoint proceeding from the value of the quality measure at the preceding waypoint;
compare the value of the quality measure at the respective waypoint to at least one threshold value; and
determine, depending on the comparison, whether or not the distance measured value at the respective waypoint has a sufficiently high quality for use during the operation of the function of the vehicle.

25. The device according to claim 24, wherein the device is configured to:
compare the value of the quality measure at the respective waypoint to an upper threshold value; and
determine that the distance measured value at the respective waypoint has a sufficiently high quality when the value of the quality measure is equal to or greater than the upper threshold value.

26. The device according to claim 25, wherein the device is configured to:
determine that the distance measured value at one or more following waypoints has a sufficiently high quality in each case as long as the value of the quality measure is greater than a lower threshold value, wherein the lower threshold value is less than the upper threshold value.

27. The device according to claim 16, wherein the device is configured to:
operate a driving function for the at least partially automated at least one of longitudinal or lateral control of the vehicle depending on the determined value of the quality measure.

28. The device according to claim 27, wherein the device is configured to:
cause or prevent automated braking of the vehicle at the object depending on the determined value of the quality measure.

29. The device according to claim 16, wherein:
the one or more surroundings sensors of the vehicle comprise a camera;
the surroundings data comprise one or more camera images which were acquired by the camera of the vehicle; and
the one or more movement sensors of the vehicle comprise at least one of a wheel speed sensor or a velocity sensor of the vehicle.

30. The device of claim 29, wherein the camera is a mono camera.

31. A method for checking distance measured values with respect to a distance of a vehicle to an object during an approach operation of the vehicle to the object, the method comprising:
determining, at two successive waypoints on a roadway to the object, in each case a distance measured value on the basis of surroundings data from one or more surroundings sensors of the vehicle;
determining, on the basis of movement data from one or more movement sensors of the vehicle, an odometry-based route distance between the two successive waypoints;
determining, on the basis of the odometry-based route distance, a value of a quality measure with respect to a quality of the distance measured values; and
operating a function of the vehicle based on the determined value of the quality measure.
